(19) United States
(12) Patent Application Publication
(10) Pub. No.: US 2012/0153836 A1
(43) Pub. Date: Jun. 21, 2012

(54) LED DRIVE CIRCUIT AND LED ILLUMINATION COMPONENT USING THE SAME

(76) Inventor: Takayuki SHIMIZU, Osaka (JP)

(21) Appl. No.: 13/305,437

(22) Filed: Nov. 28, 2011

(30) Foreign Application Priority Data
Dec. 21, 2010 (JP) 2010-284943

(51) Int. Cl. H05B 37/02

(52) U.S. Cl. 315/151; 315/250; 315/153

(57) ABSTRACT

There is provided an LED drive circuit to which a light control signal phase-controlled by a phase-control light controller is inputted and that controls a light emission portion having a plurality of LED loads that emit light of different color tones. The LED drive circuit includes a light control/color control portion that, based on the light control signal inputted, adjusts a current to be passed through each of the LED loads thereby to perform light control and color control of the light emission portion.

This application is based on Japanese Patent Application No. 2010-284943 filed on Dec. 21, 2010, the contents of which are hereby incorporated by reference.

### BACKGROUND OF THE INVENTION

1. Field of the Invention

The present invention relates to an LED drive circuit that drives an LED (light-emitting diode) and an LED illumination component using the same.

2. Description of the Prior Art

An LED is characterized by its low current consumption, long life, and so on, and its range of applications has been expanding not only to display devices but also to illumination apparatuses and the like. An LED illumination apparatus often uses a plurality of LEDs in order to attain desired illuminance.

A general-use illumination apparatus often uses a commercial alternating current power source, and considering a case where an LED illumination component is used in place of a general-use illumination component such as an incandescent lamp, it is desirable that, similarly to a general-use illumination component, an LED illumination component also be configured to use a commercial alternating current power source.

Furthermore, in seeking to perform light control of an incandescent lamp, a phase-control light controller (referred to generally as an incandescent light controller) is used in which a switching element (generally, a thyristor element or a triac element) is switched on at a certain phase angle of an alternating current power source voltage and that thus allows light control through control of power supply to the incandescent lamp to be performed easily with a simple operation of a volume element. It is known, however, that in performing light control of a low-wattage incandescent lamp by use of a phase-control light controller, connecting the incandescent lamp to the light controller leads to the occurrence of flickering or blinking, so that the light control cannot be performed properly.

It is desirable that in seeking to perform light control of an LED illumination component that uses an alternating current power source, an existing phase-control light controller for an incandescent lamp be connectable as it is to the LED illumination component. By changing only an illumination component to an LED illumination component while using existing light control equipment therewith, compared with a case of using an incandescent lamp, power consumption can be reduced considerably. Furthermore, this can also secure compatibility without requiring the light control equipment to be changed to a type dedicated to an LED illumination component and thus reduces equipment cost.

Now, FIG. 23 shows a conventional example of an LED illumination system capable of performing light control of an LED illumination component that uses an alternating current power source. An LED illumination system shown in FIG. 23 includes a commercial alternating current power source 1, a phase-control light controller 2, an LED drive circuit having a diode bridge DB1 and a current limitation portion 3, and an LED array 4 formed by connecting LEDs in series. In the phase-control light controller 2, a resistance value of a variable resistor Rvar1 is made to vary, and a triac Tri1 is thus switched on at a power source phase angle depending on the resistance value. Typically, the variable resistor Rvar1 is built in the form of a rotary knob or a slider and so configured that changing an angle of rotation of the knob or the position of the slider allows light control of an illumination component. Moreover, in the phase-control light controller 2, a capacitor C1 and an inductor L1 constitute a noise suppression circuit that reduces noise fed back into an alternating current power source line from the phase-control light controller 2. FIG. 24 shows output waveforms of the light controller and those of the diode bridge DB1, which correspond to phase angles of 0°, 45°, 90°, and 135° of the phase-control light controller 2, respectively. As the phase angle increases, an average value of an output voltage of the diode bridge DB1 decreases. It therefore follows that in a case where an LED illumination component is connected to the phase-control light controller 2, as the phase angle of the light controller increases, resulting brightness decreases.

When the phase angle of the phase-control light controller 2 is increased to decrease resulting brightness of the LEDs, if an output voltage of the diode bridge DB1 becomes smaller than a forward voltage (VF) obtained when the LED array 4 starts to glow, the LED array 4 no longer glows, and there occurs an abrupt decrease in current flowing through the light controller. Due to this abrupt decrease, the current flowing through the light controller falls below a level of an on-state holding current of the triac Tri1 in the light controller, so that the triac Tri1 is switched off to halt an output of the light controller and thus to bring about an unstable state, which results in the occurrence of brightness flickering of the LED array 4. Furthermore, when the triac Tri1 is switched from an off-state to an on-state through phase control of the output of the light controller, the LEDs are switched from an off-state to an on-state, so that there occurs an abrupt decrease in impedance of the LEDs. This might cause ringing to occur at an edge of an output voltage of the light controller, where the output voltage varies abruptly. For the above-described reason, in an LED illumination system adapted for use with a phase-control light controller, in order to prevent the triac Tri1 from being switched off when LEDs are not glowing, a current drawing circuit that forcibly passes a holding current is used. In this case, however, a drawn current is all converted to heat, which leads to deterioration in efficiency of the LED illumination system and also requires heat radiation measures to be taken.

In a case where a conventional incandescent lamp load is connected, since a filament of tungsten or the like constitutes the load, even if the triac Tri1 of the phase-control light controller 2 is switched from an off-state to an on-state, there hardly occurs a variation in impedance, and thus a low impedance state is maintained. Thus, there occurs no abrupt variation in current flowing through the phase-control light controller 2, so that a stable light control operation can be performed as long as an alternating current power source has a voltage value of around 0 V.

Furthermore, in a case of the conventional example shown in FIG. 23, when the output voltage of the diode bridge DB1 is lower than the forward voltage (VF) obtained when the LED array 4 starts to glow, the LEDs are switched off, and assuming that the alternating current power source is at a frequency of 60 Hz, since full-wave rectification is performed by the diode bridge DB1, the LEDs are switched on/off repeatedly at a frequency of 120 Hz that is double the alternating current power source frequency. This switching on/off of the LEDs causes flickering and might disadvantageously make it likely that such flickering is perceived by a user when the user quickly moves his/her line of sight in an attempt to follow a quick move in a sporting event or the like. In a case of using an incandescent lamp, since a filament has a response speed on the order of 0.1 seconds and thus does not respond to an on/off operation at 120 Hz, it is unlikely that flickering as described above occurs to a noticeable degree. On the other hand, in a case of using an LED, since its response speed is a million or more times higher than that of a filament used in an incandescent lamp, flickering tends to occur to a noticeable degree.

Moreover, FIG. 25 shows a relationship (light control curve) between a phase angle θ of the phase-control light controller and illumination brightness in each of a case of the conventional LED illumination system shown in FIG. 23 and a case of an incandescent lamp illumination system. In the conventional LED illumination system, there occurs no variation in brightness at the phase angle θ=0° to 45°, while at θ=45° or larger, the light amount decreases linearly, and at θ=130°, the LED illumination system is turned off. The incandescent lamp is characterized in that the light amount decreases gradually starting at θ=0°, which at θ=50° to 100°, decreases in parallel with the light control curve of the conventional LED illumination system and at θ=120° to 150°, decreases gradually. Brightness is perceived logarithmically by a human eye, and thus a characteristic that the light amount decreases gradually with respect to the phase angle θ is the key to fine control of a light amount at low illuminance. The conventional LED illumination system has been disadvantageous in that since it dims abruptly at around θ=130°, a light amount at a phase angle of around 120° to 150° cannot be controlled finely compared with a case of the incandescent lamp.

There has recently been invented an LED illumination component that, in order to be adaptable for use with a phase-control light controller, draws a current so that the light controller is prevented from malfunctioning due to a triac included therein being switched off and thus suppresses the occurrence of flickering even when used in combination with an already-existing phase-control light controller. It has been disadvantageous, however, that, in this case, brightness and the color temperature do not vary in the same manner as in a case where an incandescent lamp or a halogen lamp is connected to the phase-control light controller, so that a feeling of strangeness is caused. For example, in a case where an incandescent lamp is connected to a phase-control light controller, there is a characteristic that a high color temperature is obtained at high brightness, and as the phase angle is increased by operating a volume element of the phase-control light controller, the color temperature decreases. In a case where a white LED is connected to a phase-control light controller, the color temperature of light unfavorably stays substantially constant regardless of brightness. Furthermore, also regarding a variation in brightness with a variation in phase angle of a phase-control light controller, an incandescent lamp is turned off gradually at low illuminance, whereas an LED illumination component adapted for use with a light controller varies largely in brightness at low illuminance and thus is disadvantageous in that delicate control of brightness can hardly be achieved.

There is a type of LED illumination component capable of adjusting the color temperature and the light amount by use of a dedicated light controller. This type, however, requires installation work for installing the dedicated light controller. Furthermore, since an existing illumination apparatus such as an incandescent lamp is intended in illumination design, connecting an LED illumination component to already-existing equipment might result in a failure to operate illumination as intended by the original illumination design, causing a human working under the illumination to feel uncomfortable. Also from the viewpoint of utilizing already-existing equipment and design resources of illumination design, the market has been demanding an LED illumination component that, when connected to a light controller, presents substantially the same light control and color control characteristics as those of an existing illumination component (an incandescent lamp, a halogen lamp, or the like).

### SUMMARY OF THE INVENTION

It is an object of the present invention to provide an LED drive circuit and so on that, when an already-existing phase-control light controller is used, can provide light control and color control characteristics approximate to those of an existing illumination component (for example, an incandescent lamp) and thus enable light control and color control unlikely to cause a feeling of strangeness. Furthermore, it is also an object of the present invention to suppress the occurrence of flickering of an LED due to a malfunction of a phase-control light controller and to reduce a color deviation and a difference in brightness of an LED illumination component attributable to its individual variability.

The present invention provides an LED drive circuit to which a light control signal phase-controlled by a phase-control light controller is inputted and that controls a light emission portion having a plurality of LED loads that emit light of different color tones. The LED drive circuit includes a light control/color control portion that, based on the light control signal inputted, adjusts a current to be passed through each of the LED loads thereby to perform light control and color control of the light emission portion.

According to this configuration, in a case of using an already-existing phase-control light controller, light control and color control characteristics approximate to those of an existing illumination component (for example, an incandescent lamp) can be obtained, and thus light control and color control unlikely to cause a feeling of strangeness are enabled.

Furthermore, the LED drive circuit may have a configuration in which the LED loads are a white LED load and a red LED load.

Furthermore, the LED drive circuit may have a configuration in which the light control/color control portion decreases a light amount and a color temperature of the light emission portion as a phase angle of the light control signal increases.

Furthermore, the LED drive circuit may have a configuration in which a phase angle detection portion is further provided that detects a phase angle of the light control signal, and the phase angle detection portion detects the phase angle by detecting an average voltage of the light control signal.

Furthermore, the LED drive circuit may have a configuration in which a phase angle detection portion is further provided that detects a phase angle of the light control signal, and the phase angle detection portion detects the phase angle by comparing the light control signal with a reference voltage, generating a pulse signal based on a result of the comparison, and detecting a duty ratio of the generated pulse signal.

Furthermore, the LED drive circuit may have a configuration in which a detection portion is further provided that detects a light amount and a color temperature of the light emission portion, and based on the light amount and the color temperature detected by the detection portion, the light control/color control portion performs light control and color control so that the light emission portion attains a target light amount and a target color temperature that correspond to the light control signal.

Furthermore, the LED drive circuit may have a configuration in which the light control/color control portion makes each of the LED loads emit light in a time-divided manner.

Furthermore, the LED drive circuit may have a configuration in which the LED loads are the same and constant in light emission period and variable in light emission intensity.

Furthermore, the LED drive circuit may have a configuration in which the LED loads are the same and constant in light emission intensity and variable in light emission period.

Furthermore, the LED drive circuit may have a configuration in which the detection portion has a light amount sensor and integrates, using, as an integration time, a light emission period of each of the LED loads starting from a light emission timing thereof, an output of the light amount sensor thereby to detect a light amount of the each of the LED loads.

Furthermore, the LED drive circuit may have a configuration further including a low voltage detection portion that detects that a voltage of the light control signal has been lowered, and a current drawing portion that, upon the detection of the lowed voltage by the low voltage detection portion, draws a current from a power supply line for supplying power to the LED loads.

Furthermore, the LED drive circuit may have a configuration further including an edge detection portion that detects an edge of the light control signal, and a current drawing portion that, upon the detection of the edge by the edge detection portion, draws a current from a power supply line for supplying power to the LED loads.

Furthermore, the LED drive circuit may have a configuration in which a detection portion is further provided that detects illuminance and/or a color temperature of external light, and the light control/color control portion makes each of the LED loads emit light in a time-divided manner and adjusts a light amount of each of the LED loads in accordance with a result of the detection performed by the detection portion in a period during which the LED loads do not emit light.

Furthermore, an LED illumination component of the present invention has a configuration including an LED drive circuit having any of the above-described configurations, and the plurality of LED loads that are connected to an output side of the LED drive circuit and emit light of different color tones.

### DESCRIPTION OF THE DRAWINGS

FIG. 1 is a diagram showing an entire configuration of an LED illumination system according to a first embodiment of the present invention.

FIG. 2 is a diagram showing one configuration example of an LED drive circuit.

FIG. 3 is a diagram showing an example of waveforms illustrating control through current drawing.

FIG. 4 is a diagram showing an example of waveforms illustrating control through current drawing.

FIG. 5 is a diagram showing an entire configuration of an LED illumination system according to a third embodiment of the present invention.

FIG. 6 is a diagram showing an entire configuration of an LED illumination system according to a fourth embodiment of the present invention.

FIG. 7 is a diagram showing a relationship between a phase-controlled input voltage and an average voltage thereof.

FIG. 8 is a graph showing a relationship between a phase angle of a phase-control light controller and an average voltage of an input voltage.

FIG. 9 is a diagram showing an example of waveforms of an input voltage and a pulse signal outputted by a phase angle detection portion.

FIG. 10 is a graph showing a relationship between a phase angle of the phase-control light controller and a duty ratio of a pulse signal.

FIG. 11 is a diagram showing one example of respective light emission patterns of LED arrays R, G, and B.

FIG. 12 is a diagram showing one example of respective light emission patterns of the LED arrays R, G, and B.

FIG. 13 is a diagram showing one example of respective light emission patterns of LED arrays R, G, and B.

FIG. 14 is a graph showing a relationship between an input voltage of an incandescent lamp and an output light amount thereof.

FIG. 15 is a graph showing a relationship between an input voltage of the incandescent lamp and a color temperature of output light thereof.

FIG. 16 is a graph showing a relationship between a phase angle and a light amount in a case where the incandescent lamp is connected to the phase-control light controller.

FIG. 17 is a graph showing a relationship between a phase angle and a color temperature in the case where the incandescent lamp is connected to the phase-control light controller.

FIG. 18 is a graph showing color matching functions of tristimulus values.

FIG. 19 is a graph showing a Planckian locus in an xy chromaticity diagram.

FIG. 20 is a graph showing on an enlarged scale the vicinity of the Planckian locus in the xy chromaticity diagram.

FIG. 21 is a diagram showing a configuration example of a light control/color control portion.

FIG. 22 is a diagram showing another configuration example of the light control/color control portion.

FIG. 23 is a diagram showing an entire configuration of a conventional LED illumination system.

FIG. 24 is a diagram showing output waveforms of a phase-control light controller and output waveforms of a diode bridge.

FIG. 25 is a graph showing a relationship between a phase angle of the phase-control light controller and a luminous flux.

### DESCRIPTION OF THE PREFERRED EMBODIMENTS

### First Embodiment

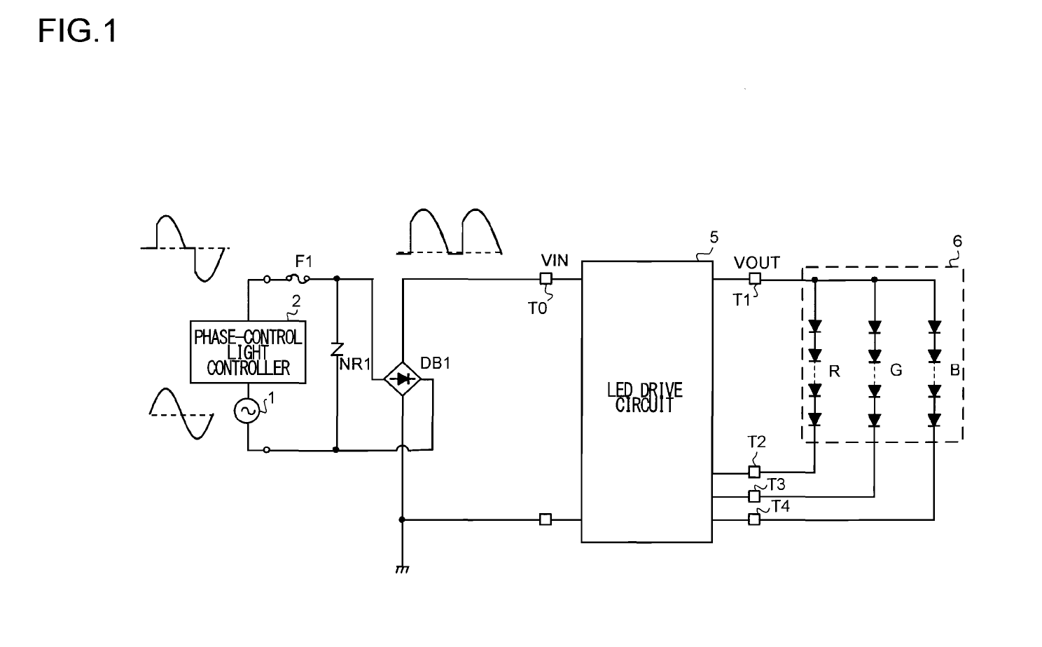

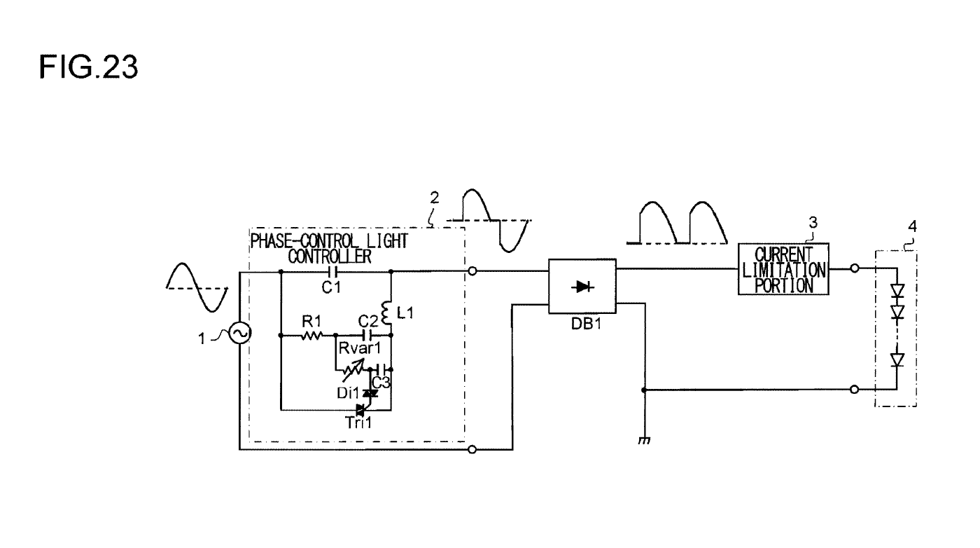

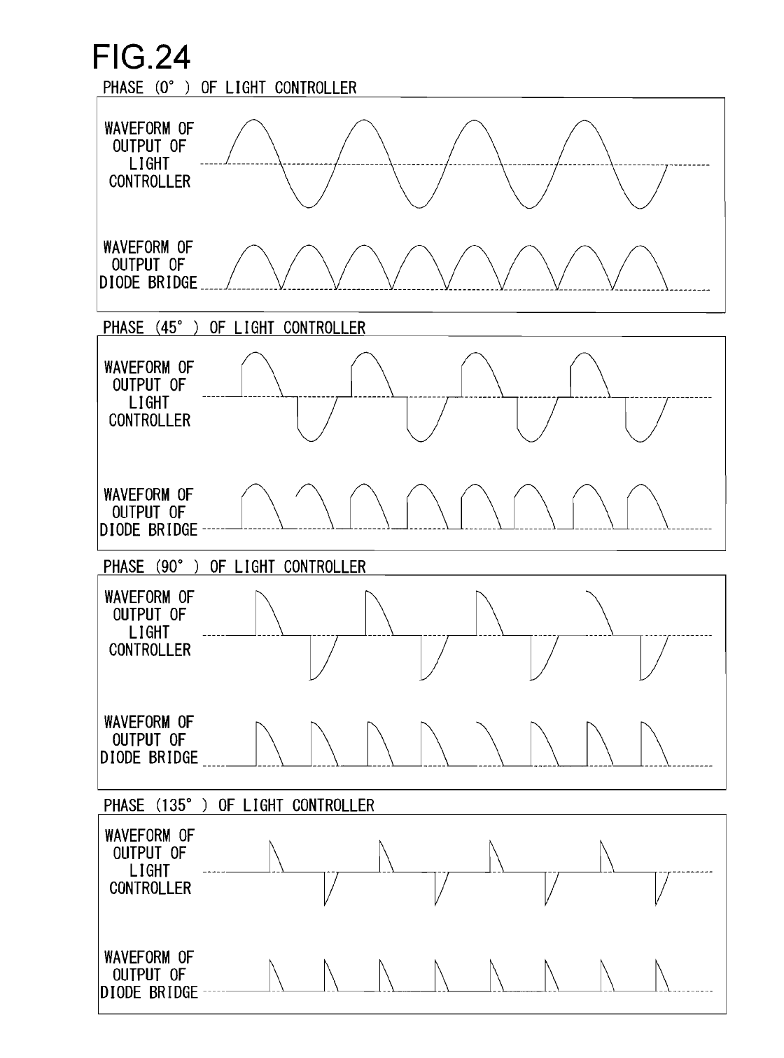

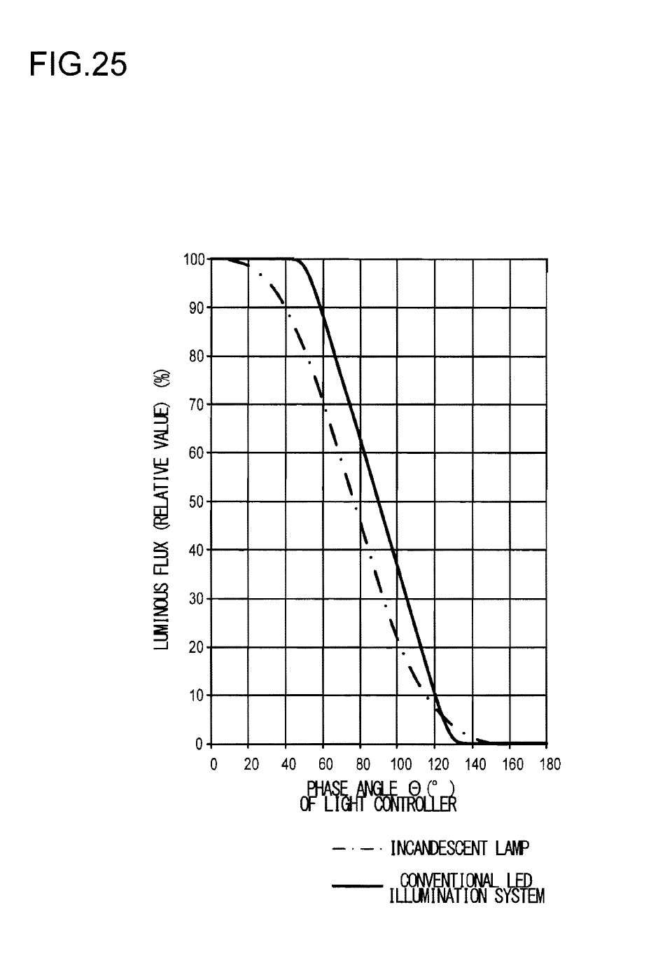

Hereinafter, an embodiment of the present invention will be described with reference to the appended drawings. FIG. 1 shows an entire configuration of an LED illumination system according to a first embodiment of the present invention. As shown in FIG. 1, the LED illumination system according to the present invention includes a commercial alternating current power source 1, a phase-control light controller 2, a fuse F1, a surge protection element NR1, a diode bridge DB1, an LED drive circuit 5 having light control and color control functions, and a light emission portion 6. The commercial alternating current power source 1 is connected to the diode bridge DB1 via the phase-control light controller 2 and the fuse F1, and the surge protection element NR1 is connected between one end of the commercial alternating current power source 1 and one end of the fuse F1. The LED drive circuit 5 is connected to an output side of the diode bridge DB1, and the light emission portion 6 is connected to an output side of the LED drive circuit 5. The phase-control light controller 2 is constituted of the foregoing element shown in FIG. 23.

The light emission portion 6 is composed of a red LED array R that emits light having a light emission wavelength in the R (red) band, a green LED array G that emits light having a light emission wavelength in the G (green) band, and a blue LED array B that emits light having a light emission wavelength in the B (blue) band. The red LED array R is connected between an output terminal T1 through which an output voltage VOUT is outputted from the LED drive circuit 5 and an R terminal T2. The green LED array G is connected between the output terminal T1 and a G terminal T3. The blue LED array B is connected between the output terminal T1 and a B terminal T4. In order to suppress a loss caused in the LED drive circuit to a minimum level, it is desirable that a difference in forward voltage among the LED arrays R, G, and B be set to be as small as possible.

The LED drive circuit 5, the light emission portion 6, and the diode bridge DB1 constitute an LED illumination component, one example of which is an LED light bulb.

The commercial alternating current power source 1 outputs a sinusoidal alternating current voltage that varies from country to country between 100 V to 250 V, and a frequency of 50 Hz or 60 Hz is used for the power source 1. When an alternating current voltage is inputted to the phase-control light controller 2, in accordance with the rotation or sliding operation for light control of a volume element, a waveform is generated that has a shape obtained by cutting away a certain phase point of an alternating current waveform. By the diode bridge DB1, full-wave rectification of an output waveform of the phase-control light controller 2 is performed, and a ripple waveform having a frequency double an input frequency (100 Hz in a case of an input frequency of 50 Hz, and 120 Hz in a case of an input frequency of 60 Hz) is inputted to an input terminal T0 of the LED drive circuit 5.

The LED drive circuit 5 detects a phase angle of an input voltage VIN having the above-described ripple waveform and controls a current value of a current to be passed through each of the red LED array R, the green LED array G, and the blue LED array B in accordance with the detected phase angle, so that the light emission portion 6 can be adjusted in terms of the light amount and the color temperature.

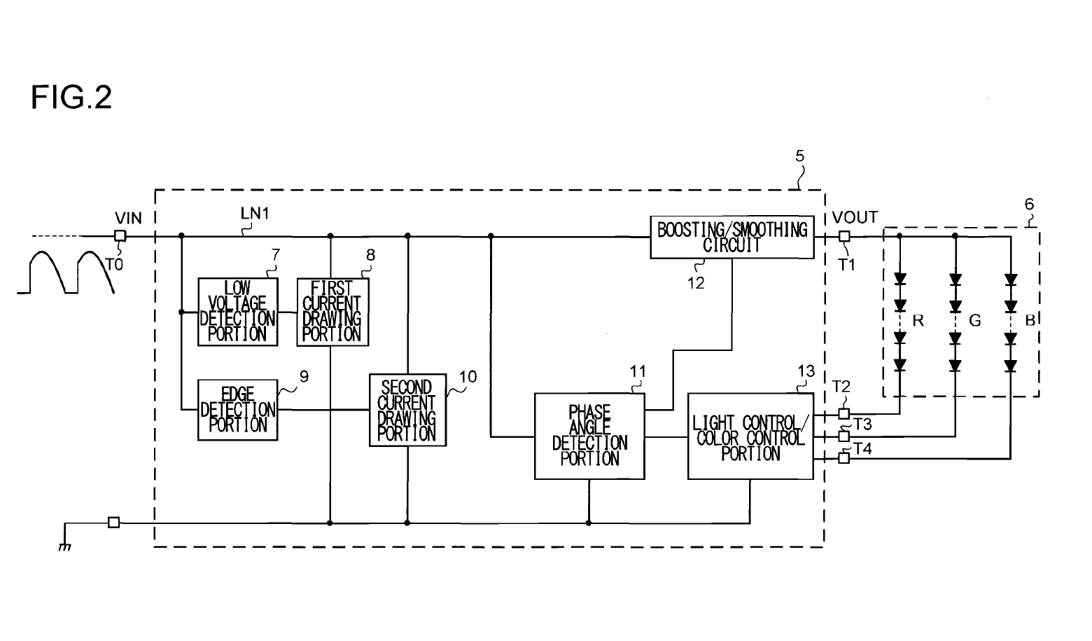

Now, FIG. 2 shows one configuration example of the LED drive circuit 5. The LED drive circuit 5 shown in FIG. 2 has a low voltage detection portion 7, a first current drawing portion 8, an edge detection portion 9, a second current drawing portion 10, a phase angle detection portion 11, a boosting/smoothing circuit 12, and a light control/color control portion 13. The boosting/smoothing circuit 12 boosts and smooths the input voltage VIN into a direct current voltage and uses it to drive and control the LED arrays of the light emission portion 6. It is also possible to omit a boosting operation and therefore to use only a smoothing circuit. In such a case, a low-ripple voltage approximate to a direct current voltage is obtained by the smoothing circuit, and thus the occurrence of flickering can be reduced. When only the smoothing circuit using a capacitor is used, however, there occurs deterioration in power factor, and in order therefore to prevent such deterioration in power factor, it is desirable that a boosting operation be performed.

The low voltage detection portion 7, upon detecting that the input voltage VIN has become lower than a threshold voltage, i.e. so low that a boosting operation can no longer be performed, outputs a detection signal as a result of the detection to the first current drawing portion 8. The first current drawing portion 8 then draws a current larger than a holding current of the phase-control light controller 2 from a power supply line LN1 for supplying power to the light emission portion 6 and thus can suppress a malfunction of the phase-control light controller 2. Furthermore, since current drawing is performed when the input voltage VIN has been lowered, a decrease in efficiency can be suppressed.

Furthermore, the edge detection portion 9, upon detecting rising of the input voltage VIN, outputs a detection signal as a result of the detection to the second current drawing portion 10. The second current drawing portion 10 then draws, from the power supply line LN1, a pulsating current larger than the current dawn by the first current drawing portion 8 and thus can prevent the phase-control light controller 2 from malfunctioning due to resonance.

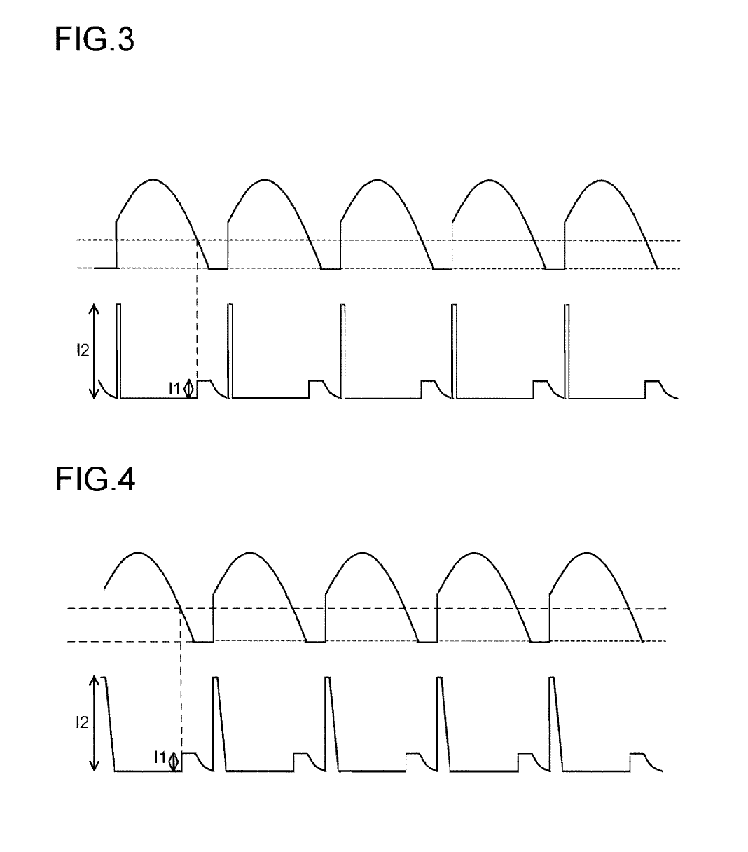

FIG. 3 shows the input voltage VIN (upper row) and waveforms of currents drawn respectively by the first current drawing portion 8 and the second current drawing portion 10 (lower row) in a case where the phase-control light controller 2 is at a phase angle of 45°. A first drawn current I1 is shown to have a waveform of a current drawn by the first current drawing portion 8, and a second drawn current I2 is shown to have a waveform of a current drawn by the second current drawing portion 10. Furthermore, the second drawn current I2 may be set to have a trapezoidal waveform as shown in FIG. 4, in which case the effect of suppressing a malfunction of the phase-control light controller 2 due to resonance may be enhanced. Furthermore, when set to have a trapezoidal waveform, the second drawn current I2 may be able to be reduced in magnitude, in which case a decrease in efficiency caused by the second drawn current I2 may be able to be reduced. The above-described two current drawing portions thus prevent the phase-control light controller 2 from malfunctioning, as a result of which the occurrence of flickering of light can be suppressed.

Furthermore, the phase angle detection portion 11 detects the phase angle of the input voltage VIN, namely, the phase angle of the phase-control light controller 2, and the light control/color control portion 13 adjusts a current value of a current to be passed through each of the LED arrays of the respective colors of the light emission portion 6 in accordance with the detected phase angle, so that the light emission portion 6 can output light having a light amount and a color temperature that correspond to the phase angle.

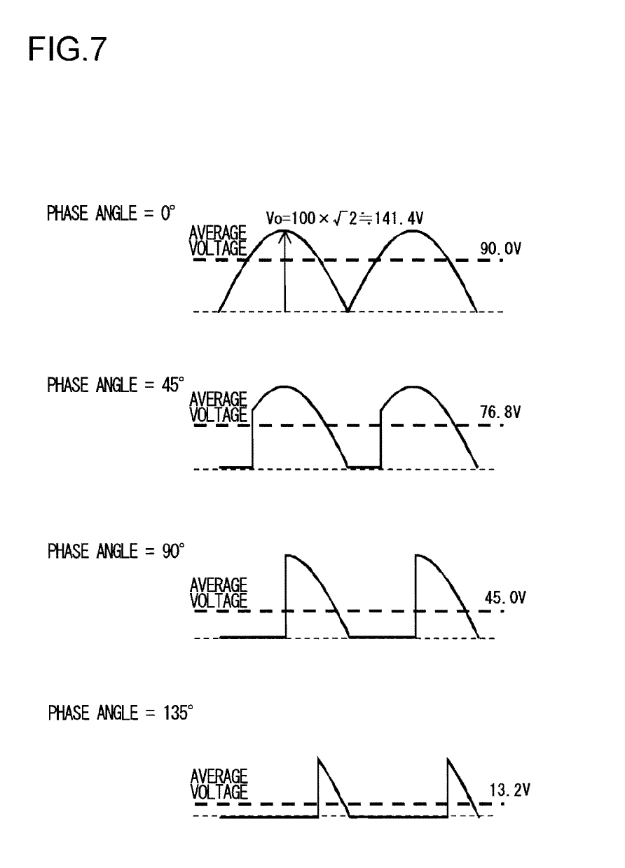

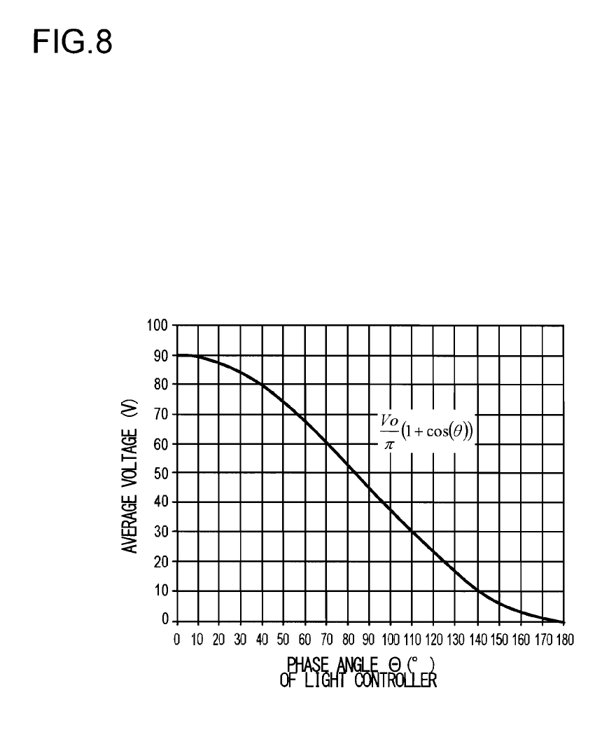

Referring to FIGS. 7 and 8, the following description describes one example of how the phase angle detection portion 11 detects a phase angle. FIG. 7 is a diagram showing waveforms of the input voltage VIN and average voltages thereof in cases where the phase-control light controller 2, to which the commercial alternating current power source 1 at 100 V is connected, is at phase angles of 0°, 45°, 90°, and 135°, respectively. As the phase angle increases, the average voltage decreases, and thus detecting the average voltage allows the phase angle of the phase-control light controller 2 to be detected. FIG. 8 shows a relationship between the phase angle of the phase-control light controller 2 and the average voltage. The phase angle detection portion 11 outputs phase angle information (a voltage level, a digital signal, and so on) corresponding to an average voltage detected.

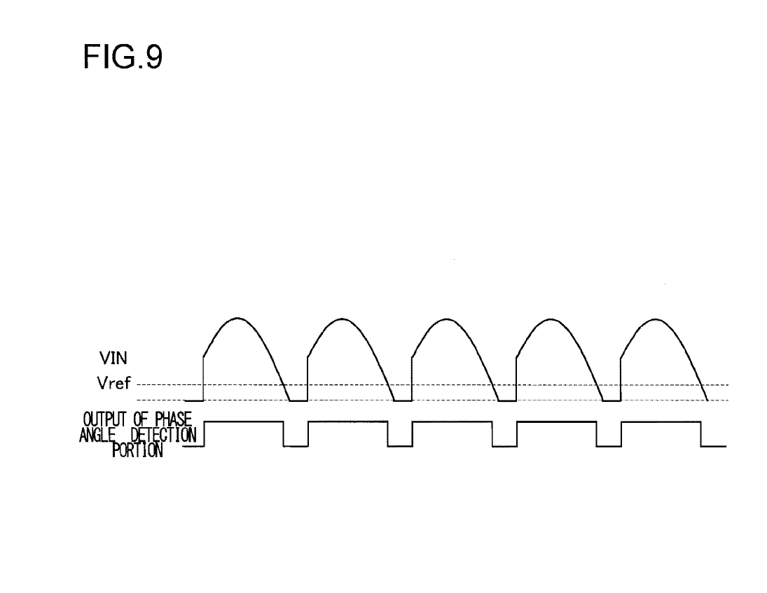

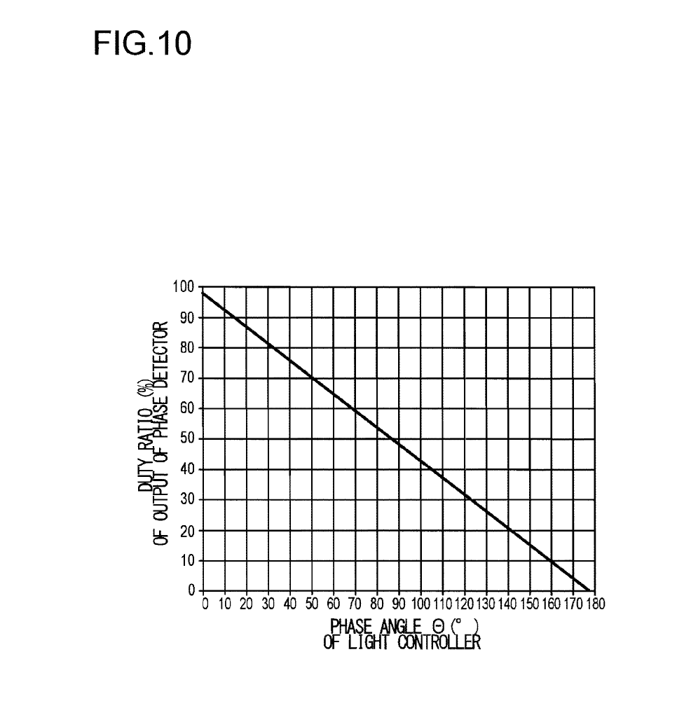

Furthermore, referring to FIGS. 9 and 10, the following describes another example of how the phase angle detection portion 11 detects a phase angle. As shown in FIG. 9, the phase angle detection portion 11 compares the input voltage VIN with a reference voltage Vref, and based on a result of the comparison, generates a pulse signal having a high level when the input voltage VIN has a value exceeding the reference voltage Vref, which then is outputted. FIG. 10 shows a relationship between the phase angle of the phase-control light controller 2 and a duty ratio of the pulse signal. The duty ratio of the pulse signal has a linear characteristic with respect to the phase angle of the light controller, and thus precise detection of a phase angle is enabled. The light control/color control portion 13 and the boosting/smoothing circuit 12 detect the duty ratio of the pulse signal.

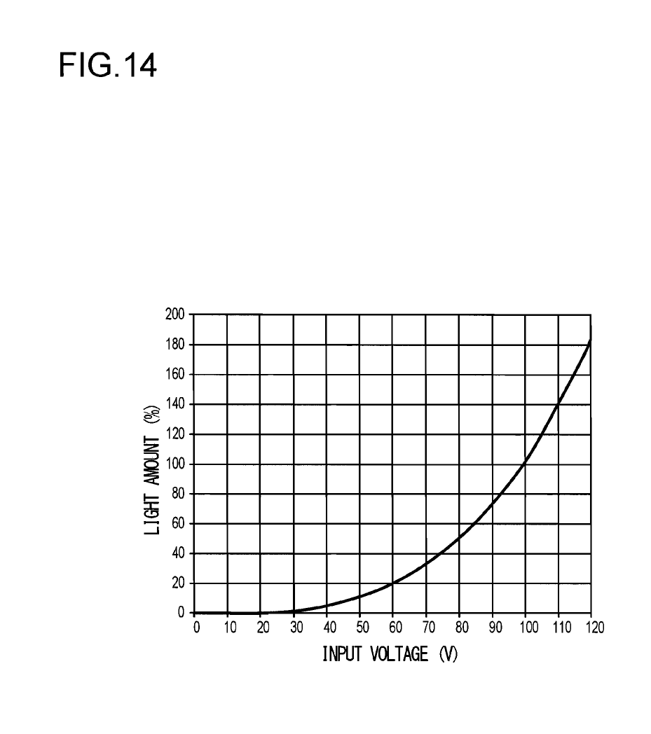

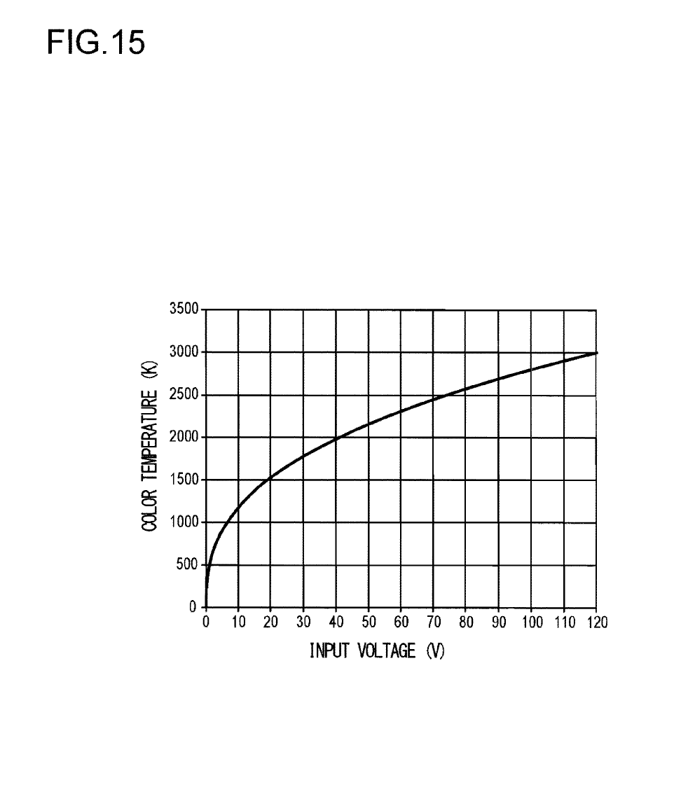

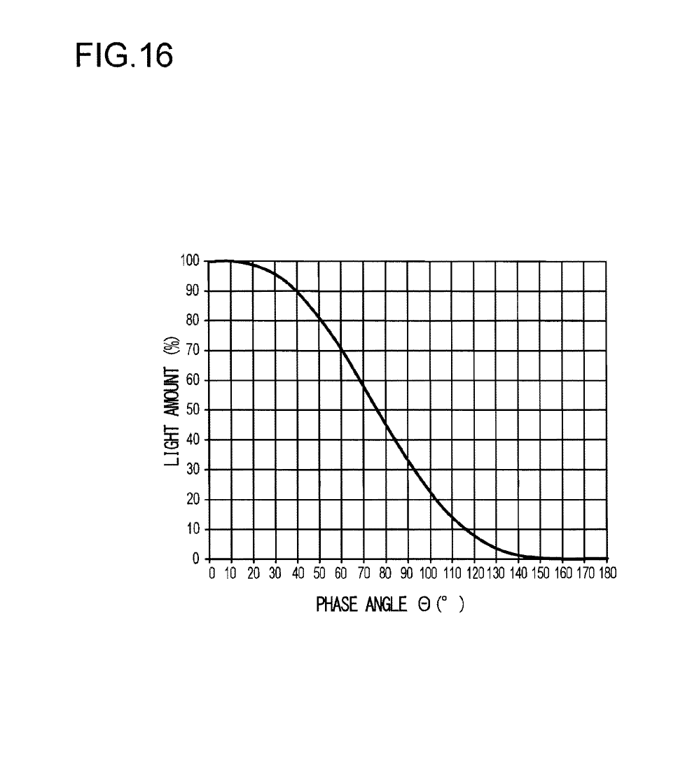

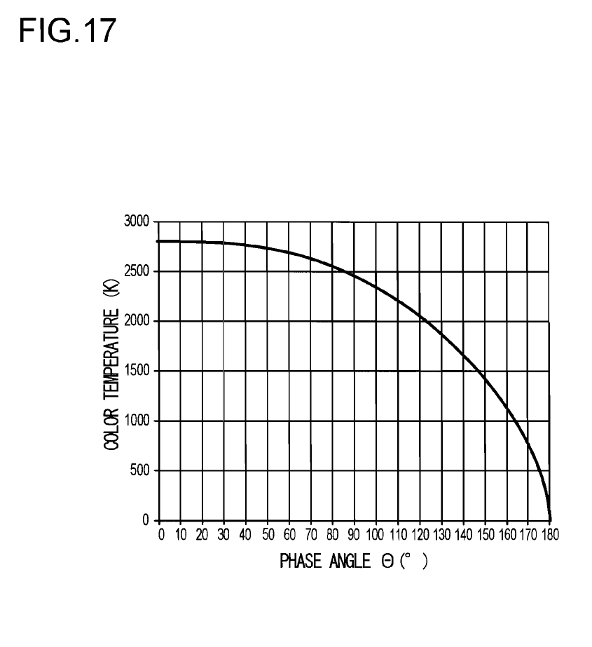

Now, the following describes variations in light amount and in color temperature in a case where an incandescent lamp is connected to the phase-control light controller 2. FIG. 14 shows a relationship between an input voltage of the incandescent lamp and an output light amount thereof, exhibiting a characteristic that as the input voltage rises, the light amount increases. FIG. 15 is a diagram showing a relationship between the input voltage of the incandescent lamp and a color temperature of output light thereof. This relationship exhibits a characteristic that as the input voltage is decreased, the color temperature decreases, and as the input voltage is increased, the color temperature increases. Based on the characteristics shown in FIGS. 14 and 15, respectively, FIGS. 16 and 17 show a relationship between the phase angle and the light amount and a relationship between the phase angle and the color temperature, respectively, in the case where the incandescent lamp is connected to the phase-control light controller 2. The light control/color control portion 13 adjusts a current value of a current to be passed through each of the LED arrays of the respective colors of the light emission portion 6 in accordance with an output of the phase angle detection portion 11, namely, in accordance with a phase angle detected, thereby to control so that the relationship between the phase angle and a light amount of output light of the light emission portion 6 and the relationship between the phase angle and the color temperature of output light of the light emission portion 6 are consistent with the light control characteristic shown in FIG. 16 and the color control characteristic shown in FIG. 17, which are obtained in the case of the incandescent lamp, respectively. Furthermore, the boosting/smoothing circuit 12 adjusts an output voltage in accordance with the output of the phase angle detection portion 11, namely, in accordance with a phase angle detected.

Now, the following describes in detail how the light amount and the color temperature are adjusted. A light amount of an LED is in a substantially proportional relationship with a driving current of the LED, and thus a light amount of each of the LED arrays R, G, and B of the respective colors can be controlled using a driving current. Where currents flowing through the LED arrays R, G, and B are indicated as Ir, Ig, and Ib, respectively, the light amounts of the LED arrays are expressed as functions of a driving current, i.e. as

Φr(Ir),
Φg(Ig), and
Φb(Ib), respectively.
A light amount Φ of the light emission portion 6 as a whole is therefore determined as a sum of the light amounts of the LED arrays R, G, and B of the respective colors, i.e. by

Φ=Φr(Ir)+Φg(Ig)+Φb(Ib).

Thus, by controlling a current value of a current to be passed through each of the LED arrays R, G, and B of the respective colors in accordance with the output of the phase angle detection portion 11, brightness can be adjusted.

Next, the following describes control of a color temperature of light emitted from the light emission portion 6. When a given current Io is passed through each of the LED arrays R, G, and B of the respective colors, spectral characteristics of light emitted from the LED arrays of the respective colors can be expressed as functions of a wavelength λ of light, i.e. as

### Ro(λ),

### Go(λ),and

Bo(λ), respectively.

Where currents flowing through the LED arrays R, G, and B of the respective colors are indicated as Ir, Ig, and Ib, respectively, a spectral characteristic P(λ) of a light source as a whole, in which light of the three types of LED arrays is mixed together, is expressed by

P(λ)=(Ir·Ro(λ)+Ig·Go(λ)+Ib·Bo(λ))/Io.

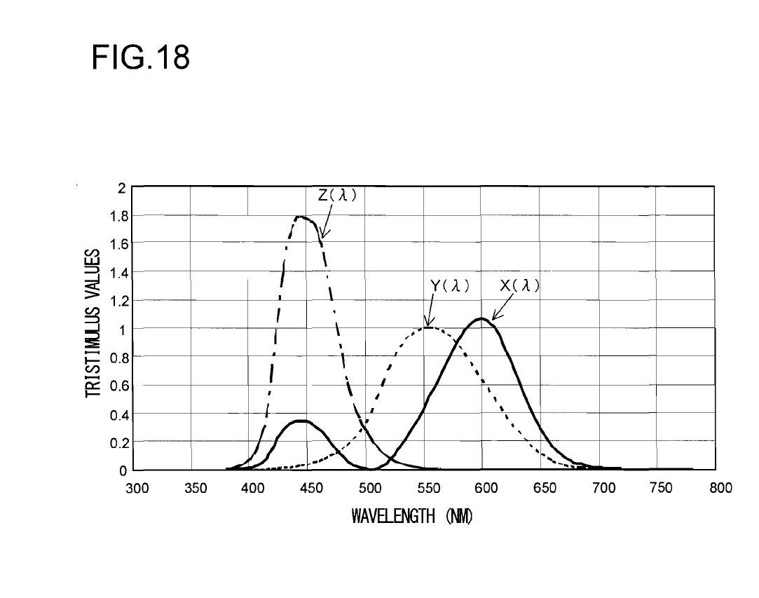

Coordinates on the xy chromaticity diagram of the light source having the above-mentioned spectral characteristic P(λ) can be determined based on color matching functions of tristimulus values shown in FIG. 18. Where outputs of light-receiving elements having three types of spectral characteristics X(λ), Y(λ), and Z(λ), respectively, in a case where light having the spectral characteristic P(λ) is incident thereon are indicated as IPD_X, IPD_Y, and IPD_Z, respectively, the following expressions hold:

IPD_{—}X=□P(λ)·X(λ)·dλ,

IPD_{—}Y=□P(λ)·Y(λ)·dλ,

IPD_{—}Z=□P(λ)·Z(λ)·dλ.

Coordinates x and y on the xy chromaticity diagram are expressed by

x=IPD_{—}X/(IPD_{—}X+IPD_{—}Y+IPD_{—}Z),

and

y=IPD_{—}Y/(IPD_{—}X+IPD_{—}Y+IPD_{—}Z),

respectively.
Thus, by making the currents Ir, Ig, and Ib to be passed respectively through the LED arrays R, G, and B of the respective colors vary, coordinates of P(λ) on the xy chromaticity diagram can be shifted.

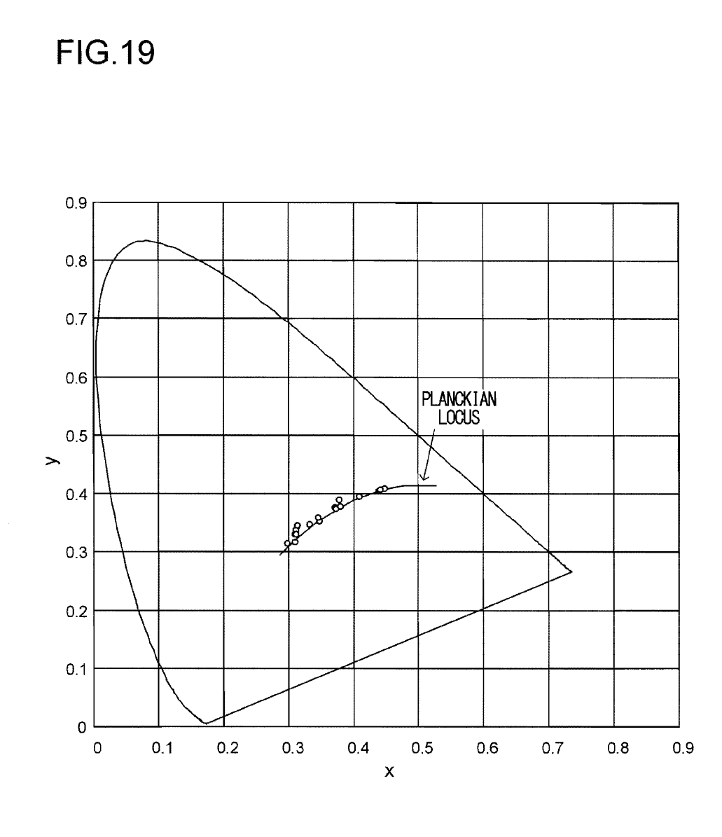

FIG. 19 is a graph showing a locus of a black body radiation light source on the xy chromaticity diagram with respect to a varying color temperature of the light source, which is referred to as a Planckian locus. When a blue component having a wavelength around 450 nm is relatively increased, IPD_Z increases to decrease the coordinates x and y, so that the color temperature increases. Furthermore, when a red component having a wavelength around 600 nm is relatively increased, IPD_X increases to increase the coordinates x and y, so that the color temperature decreases. By making Ir, Ig, and Ib vary so that the coordinates of P(λ) on the xy chromaticity diagram lie along the Planckian locus, light having an arbitrary color temperature can be outputted.

Since the following expression holds:

P(λ)=((Ir/Ig)·Ro(λ)+Go(λ)+(Ib/Ig)·Bo(λ))·(Ig/Io),

the coordinates x and y of the light source on the xy chromaticity diagram are expressed as functions of (Ir/Ig) and (Ib/Ig), respectively. By maintaining (Ir/Ig) and (Ib/Ig) at constant values, it is possible to make the light amount vary without making the color temperature vary, thereby allowing the light amount and the color temperature to be controlled independently of each other.

As described above, the light control/color control portion 13 adjusts the currents Ir, Ig, and Ib flowing through the LED arrays R, G, and B of the respective colors in accordance with a phase angle detected, thereby to control so that a relationship between the phase angle of the phase-control light controller 2 and the light amount and a relationship between the phase angle of the phase-control light controller 2 and the color temperature are consistent with the light control characteristic shown in FIG. 16 and the color control characteristic shown in FIG. 17, respectively. Thus, the same light control and color control characteristics as those of an incandescent lamp can be obtained, so that even in a case where, in place of an incandescent lamp, an LED illumination component is connected to existing light control equipment, there is caused almost no feeling of strangeness, and low power consumption can be achieved. Furthermore, instead of direct currents, pulsating currents having average currents equal in level to Ir, Ig, and Ib, respectively, may be passed through the LED arrays of the respective colors.

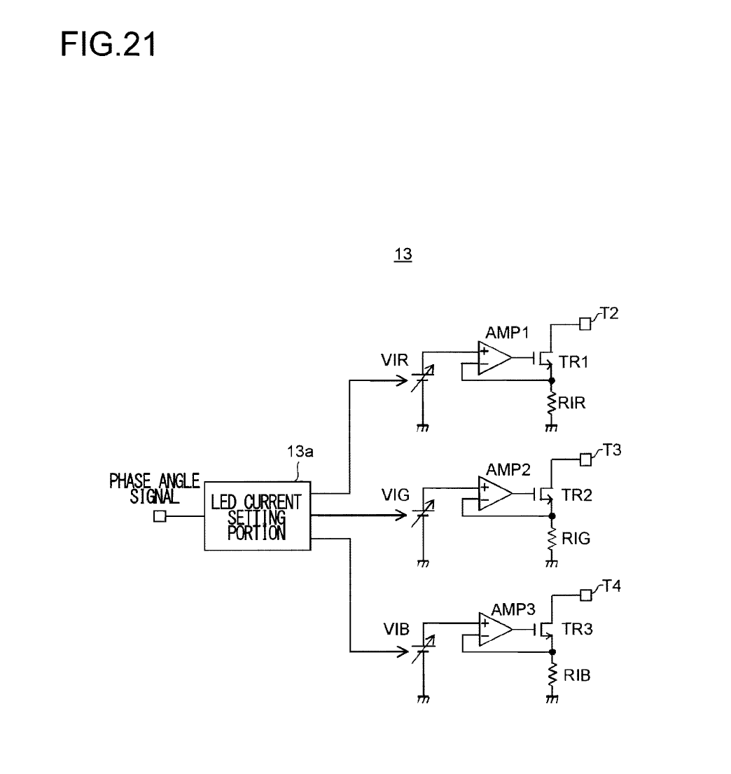

FIG. 21 shows a configuration example of the light control/color control portion 13 in a case where direct currents are passed through the LED arrays. The light control/color control portion 13 shown in FIG. 21 has an LED current setting portion 13a, voltage sources VIR, VIG, and VIB, operational amplifiers AMP1, AMP2, and AMP3, NchMOS transistors TR1, TR2, and TR3, and resistors RIR, RIG, and RIB. A source of the NchMOS transistor TR1 is connected to an R terminal T2, while a drain thereof is connected to one end of the resistor RIR, and an output of the operational amplifier AMP1 is connected to a gate thereof The other end of the resistor RIR is grounded. The voltage source VIR is connected to a non-inverting terminal of the operational amplifier AMP1, and a connection point between the drain of the NchMOS transistor TR1 and the resistor RIR is connected to an inverting terminal thereof. A G terminal T3 and a B terminal T4 are configured similarly to the above, detailed descriptions of which are therefore omitted.

Currents flowing through the R terminal T2, the G terminal T3, and the B terminal T4 are expressed by

I(T2)=VIR/RIR,

I(T3)=VIG/RIG,

and

I(T4)=VIB/RIB,

respectively.
Thus, the LED current setting portion 13a can control a current to be passed through each the LED arrays R, G, and B of the respective colors by controlling VIR, VIG, and VIB in accordance with a phase angle detected.

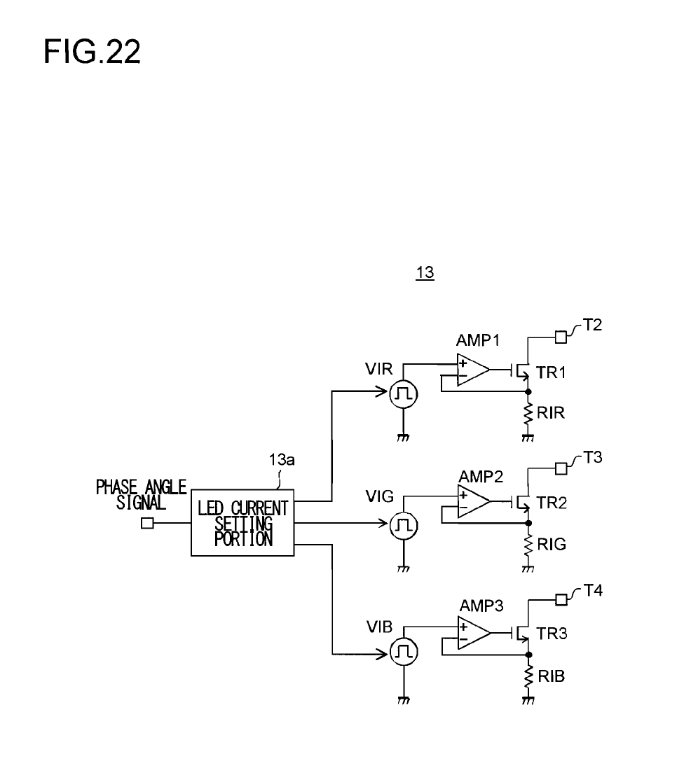

Furthermore, FIG. 22 shows a configuration example of the light control/color control portion 13 in a case where pulsating currents are passed through the LED arrays. The light control/color control portion 13 shown in FIG. 22 has an LED current setting portion 13a, pulse voltage sources VIR, VIG, and VIB, operational amplifiers AMP1, AMP2, and AMP3, NchMOS transistors TR1, TR2, and TR3, and resistors RIR, RIG, and RIB. A source of the NchMOS transistor TR1 is connected to an R terminal T2, while a drain thereof is connected to one end of the resistor RIR, and an output of the operational amplifier AMP1 is connected to a gate thereof. The other end of the resistor RIR is grounded. The pulse voltage source VIR is connected to a non-inverting terminal of the operational amplifier AMP1, and a connection point between the drain of the NchMOS transistor TR1 and the resistor RIR is connected to an inverting terminal thereof A G terminal T3 and a B terminal T4 are configured similarly to the above, detailed descriptions of which are therefore omitted.

Where amplitudes of the pulse voltage sources are indicated as VIR, VIG, and VIB, respectively, and duty ratios thereof as DIR, DIG, and DIB, respectively, average currents of pulsating currents flowing through the R terminal T2, the G terminal T3, and the B terminal T4 are expressed by

I(T2)=DIR·VIR/RIR,

I(T3)=DIG·VIG/RIG,

and

I(T4)=DIB·VIB/RIB,

respectively.
Thus, the LED current setting portion 13a can control a current to be passed through each of the LED arrays R, G, and B of the respective colors by controlling the amplitudes or duty ratios of the pulse voltage sources in accordance with a phase angle detected.

Moreover, through the use of the LED illumination system configured as above, it is also possible to make the color temperature vary dynamically with the phase angle of the light controller. For example, the color temperature of illumination can even be set to be as high as “daylight” or “neutral” when the phase angle of the light controller is small and to be “incandescent” when the phase angle is large and thus can be made to vary in a wider range than in the case of an incandescent lamp, so that a broader range of applications can be achieved. More specifically, for example, with respect to variations in color temperature with the phase angle shown in FIG. 17, Ir, Ig, and Ib are controlled so that a “daylight” color temperature at a phase angle of 0° is 6500K, a “neutral” color temperature at a phase angle of 60° is 5000K, and an “incandescent” color temperature at a phase angle of 150° is 2800K, and thus the color temperature of the light source can be made to vary. Compared with the foregoing control for achieving consistency with a variation in color temperature with the phase angle of the light controller in the case where an incandescent lamp is connected to the light controller, when the phase angle is small, a relative value (Ib/Ig) of Ib is further increased so that the color temperature can be increased, and thus the color temperature of the light source can be set to vary in a wider range than in the case of an incandescent lamp, so that a broader range of applications can be achieved.

### Second Embodiment

The LED arrays R, G, and B of the respective colors in the light emission portion 6 shown in FIG. 2 may be replaced with two types of LED arrays, which are a white LED array and a red LED array. In this case, a current value of a current to be passed through each of the white LED array and the red LED array is controlled in accordance with the phase angle of the phase-control light controller 2, and thus a relationship between the phase angle and a light amount and a relationship between the phase angle and a color temperature approximate respectively to the light control and color control characteristics of an incandescent lamp can be obtained.

Now, the following describes in detail how the light amount and the color temperature are adjusted. A light amount of an LED is in a proportional relationship with a driving current of the LED, and thus a light amount of each of the white and red LED arrays can be controlled using a driving current. Where currents flowing through the white and red LED arrays are indicated as Iw and Ir, respectively, the light amounts of the LED arrays are expressed as functions of a driving current, ie. as

Φw(Iw) and
Φr(Ir), respectively.
A light amount Φ of the light emission portion 6 as a whole is therefore determined as a sum of the light amounts of the white and red LED arrays, i.e. by

Φ=Φw(Iw)+Φr(Ir).

Thus, by controlling a current to be passed through each of the LED arrays in accordance with the output of the phase angle detection portion 11, brightness can be adjusted.

Next, the following describes control of the color temperature. When a given current Io is passed through each of the white and red LED arrays, spectral characteristics of light emitted from the LED arrays can be expressed as functions of a wavelength λ of light, i.e. as

### Wo(λ) and

Ro(λ), respectively.
Where currents flowing through the white and red LED arrays are indicated as Iw and Ir, respectively, a spectral characteristic P(λ) of a light source as a whole, in which light of the two types of LED arrays is mixed together, is expressed by

P(λ)=(Iw·Wo(λ)+Ir·Ro(λ))/Io.

Coordinates on the xy chromaticity diagram of the light source having the above-mentioned spectral characteristic P(λ) can be determined based on the color matching functions of tristimulus values shown in FIG. 18. Where outputs of light-receiving elements having three types of spectral characteristics X(λ), Y(λ), and Z(λ), respectively, in a case where light having the spectral characteristic P(λ) is incident thereon are indicated as IPD_X, IPD_Y, and IPD_Z, respectively, the following expressions hold:

IPD_{—}X=□P(λ)·X(λ)·dλ,

IPD_{—}Y=□P(λ)·Y(λ)·dλ,

IPD_{—}Z=□P(λ)·Z(λ)·dλ.

Coordinates x and y on the xy chromaticity diagram are expressed by

x=IPD_{—}X/(IPD_{—}X+IPD_{—}Y+IPD_{—}Z),

and

y=IPD_{—}Y/(IPD_{—}X+IPD_{—}Y+IPD_{—}Z),

respectively.

By making the currents Iw and Ir to be passed respectively through the white and red LED arrays vary, coordinates of P(λ) on the xy chromaticity diagram can be shifted. When a current to be passed through the red LED array, namely, Ir is decreased, the color temperature increases, and when Ir is increased, the color temperature decreases. In a case where three primary colors of R, G, and B are used as in the first embodiment, it is possible to control so that coordinates on the xy chromaticity diagram lie exactly along the Planckian locus. On the other hand, in a case of making Iw and Ir vary, since the number of parameters used is two, the coordinates of P(λ) on the xy chromaticity diagram cannot be made to lie exactly along the Planckian locus. This, however, often is not a serious issue from a practical standpoint since even when coordinates on the xy chromaticity diagram do not exactly coincide with the Planckian locus, the color temperature of the light source can be defined as long as the coordinates lie within a certain range from the Planckian locus.

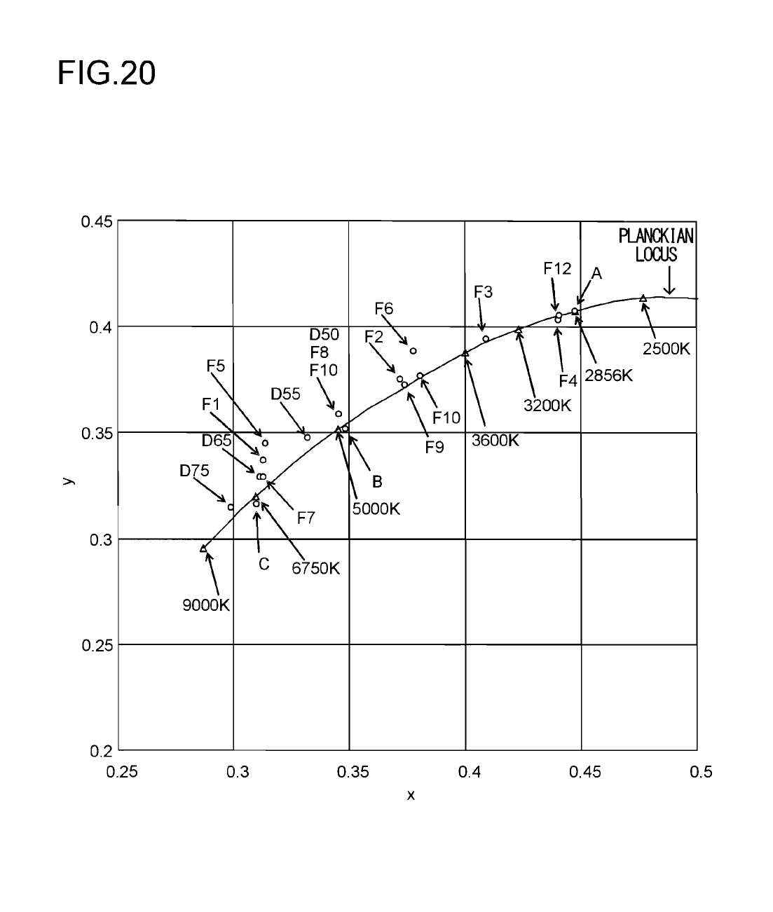

FIG. 20 is a diagram showing on an enlarged scale an area including the Planckian locus in the graph of FIG. 19, in which x and y coordinates of light outputted from each of commercially available illumination devices (fluorescent lamps (F1 to F12) and standard light sources (an A light source, a B light source, a C light source, a D50 light source, a D55 light source, a D65 light source, and a D75 light source)) are plotted on the xy chromaticity diagram. In practice, as shown in FIG. 20, even with the standard light sources, the coordinates of light emitted therefrom do not necessarily exactly coincide with the Planckian locus.

As an expression for calculating a color temperature based on coordinates on the xy chromaticity diagram, McCamy's formula is known and given as follows:

Color temperature=449n³+3525n²+6823.3n+5520.33,

where

n=(x−0.3320)/(0.1858−y).

Using this expression, a color temperature can be determined based on coordinates on the xy chromaticity diagram.

Furthermore, since the following expression holds:

P(λ)=(Wo(λ)+(Ir/Iw)·Ro(λ))/(Iw/Io),

by maintaining (Ir/Iw) at a constant value, it is possible to make the light amount vary without making the color temperature vary, thereby allowing the light amount and the color temperature to be controlled independently of each other. As described above, the currents Ir and Iw flowing respectively through the white and red LED arrays are controlled in accordance with a phase angle detected by the phase angle detection portion 11, and thus a relationship between the phase angle of the phase-control light controller 2 and the light amount and a relationship between the phase angle of the phase-control light controller 2 and the color temperature approximate respectively to the light control and color control characteristics of an incandescent lamp can be obtained, so that compared with the case of using the three types of LED arrays R, G, and B, cost reduction can be achieved.

### Third Embodiment

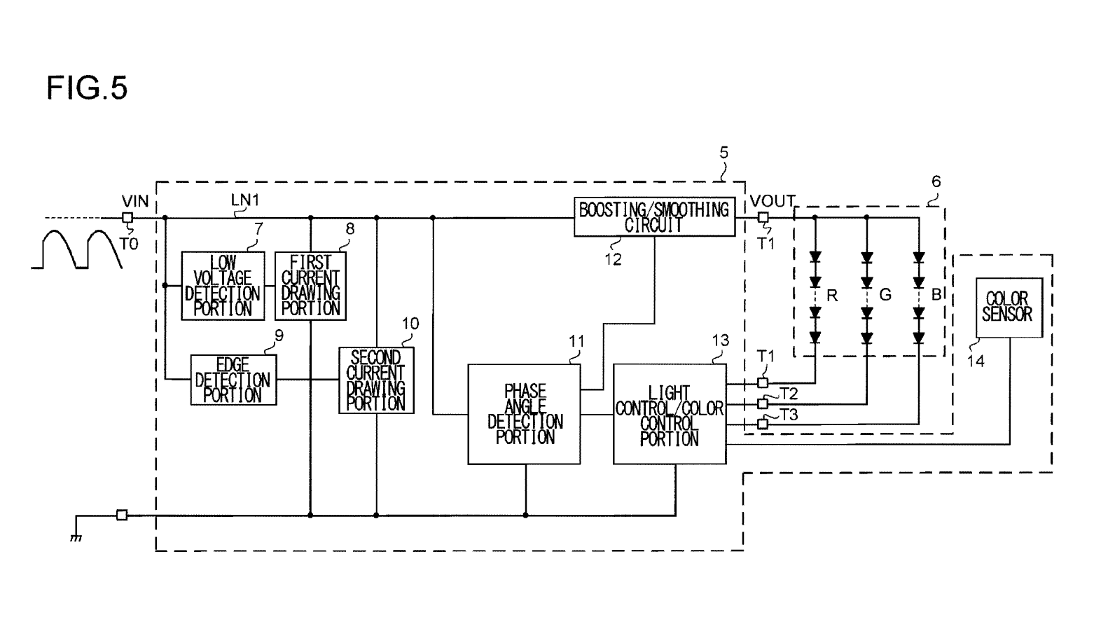

FIG. 5 shows an entire configuration of an LED illumination system according to a third embodiment of the present invention. A color sensor 14 is connected to a light control/color control portion 13 of the LED illumination system in order to measure in real time a light amount and a color temperature of light outputted by a light emission portion 6 composed of LED arrays R, G, and B so that feedback control is performed based on results of the measurement. This enables extremely precise control of a light amount and a color temperature.

Now, the following describes detection of a light amount and a color temperature by the color sensor 14. FIG. 18 shows spectral characteristics of the tristimulus values used as a basis for determining coordinates of a light source on the xy chromaticity diagram. The color sensor 14 has light-receiving elements having spectral characteristics X(λ), Y(λ), and Z(λ), respectively, and thus can measure a color temperature and a light amount of the light source by use of these light-receiving elements. Where outputs of the light-receiving elements having the spectral characteristics X(λ), Y(λ), and Z(λ), respectively, in a case where light of an arbitrary illumination device is incident thereon are indicated as IPD_X, IPD_Y, and IPD_Z, respectively, coordinates on the xy chromaticity diagram, which represent a hue of the incident light, can be given by computations of the following expressions:

x=IPD_{—}X/(IPD_{—}X+IPD_{—}Y+IPD_{—}Z),

y=IPD_{—}Y/(IPD_{—}X+IPD_{—}Y+IPD_{—}Z).

Moreover, since Y(λ) has a spectral characteristic consistent with a standard luminosity factor, the light amount of the light source can be estimated using IPD_Y.

Furthermore, even if spectral sensitivity characteristics of the light-receiving elements of the color sensor 14 are not compliant with the tristimulus values, they can be transformed to coordinates on the xy chromaticity diagram by coordinate transformation using a transformation matrix.

As described above, coordinates on the xy chromaticity diagram (namely, a color temperature) and a light amount are measured by the color sensor 14, and based on the color temperature and light amount thus measured, the light control/color control portion 13 controls a current value of a current to be passed through each of the LED arrays R, G, and B of the respective colors so that the light emission portion 6 attains a target light amount and a target color temperature that correspond to a phase angle. Thus, a color deviation and a difference in brightness of an LED illumination component attributable to its individual variability can be reduced.

### Fourth Embodiment

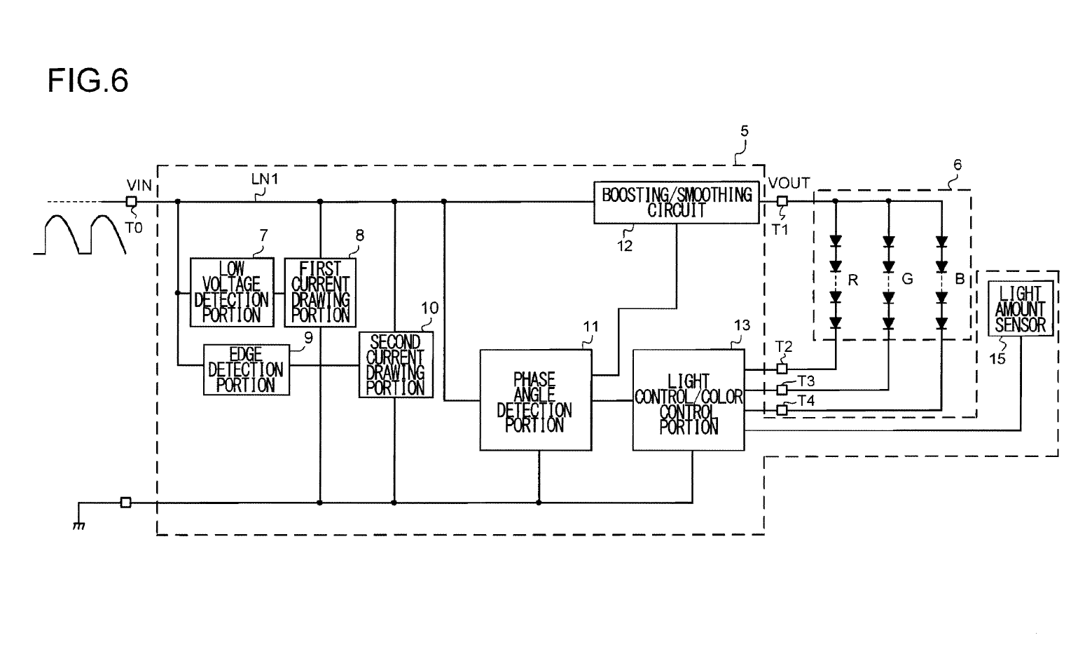

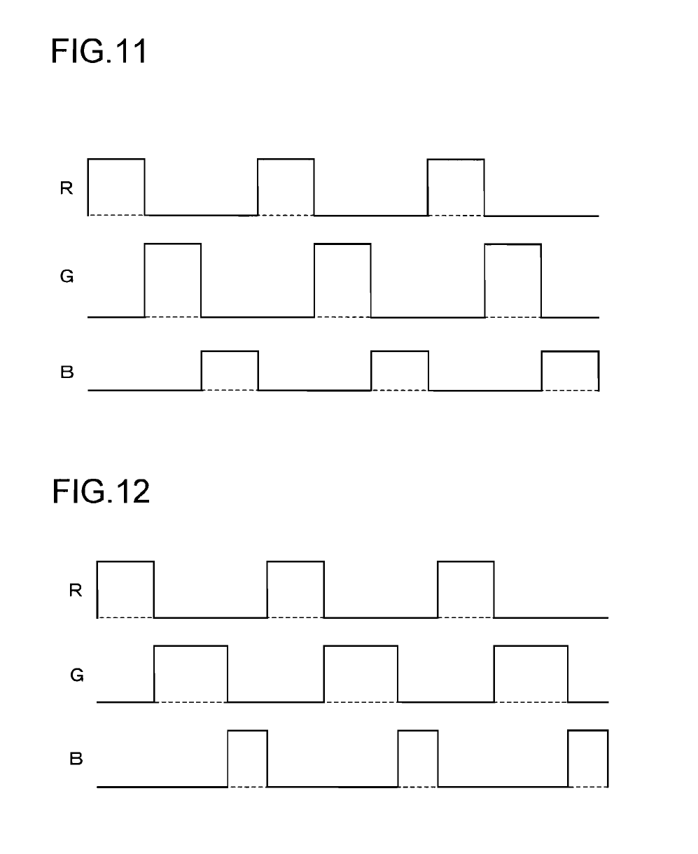

FIG. 6 shows an entire configuration of an LED illumination system according to a fourth embodiment of the present invention. In the LED illumination system shown in FIG. 6, a light amount sensor 15 is connected to a light control/color control portion 13. In this case, first, at an initial stage, the light control/color control portion 13 passes pulsating currents having average currents equal in level to currents Ir, Ig, and lb of LED arrays R, G, and B of the respective colors, respectively, so that a target light amount and a target color temperature that correspond to a phase angle detected by a phase angle detection portion 11 are attained. At this time, the LED arrays of the respective colors are set so that the currents are passed therethrough for the same length of time as an on-period, with the on-periods thereof staggered in the order of the LED arrays R, G, and B. Thus, as shown in FIG. 11, light emission timings of the LED arrays R, G, and B are staggered, so that the LED arrays R, G, and B can be set to be the same in light emission period and made to vary in light emission intensity.

Then, the light control/color control portion 13 integrates, at the respective light emission timings of the LED arrays R, G, and B and using the respective light emission periods thereof as integration times, outputs of the light amount sensor 15 that has sensitivity in R, G, and B regions and thus has a wide range of spectral sensitivity characteristics thereby to detect respective light amounts of the LED arrays R, G, and B. The light amounts thus detected are summed, and thus a light amount of a light emission portion 6 is detected. Furthermore, the LED arrays R, G, and B are made to emit light in a time-divided manner, and the light thus emitted is inputted to the light amount sensor 15. Where average outputs of the light amount sensor 15 obtained in this case are indicated as Ipd_R, Ipd_G, and Ipd_B, respectively, using a transformation matrix experimentally determined beforehand, coordinates on the xy chromaticity diagram (a color temperature) can be approximately determined by the following expressions.

$$( \begin{matrix}X \\ Y \\ Z\end{matrix} ) = ( \begin{matrix}{C}_{11} & {C}_{12} & {C}_{13} \\ {C}_{21} & {C}_{22} & {C}_{23} \\ {C}_{31} & {C}_{32} & {C}_{33}\end{matrix} ) \cdot ( \begin{matrix}Ipd\_R \\ Ipd\_G \\ Ipd\_B\end{matrix} )$$

$$x = \frac{X}{X + Y + Z}$$

$$y = \frac{Y}{X + Y + Z}$$

Based on the light amount and color temperature thus detected, the light control/color control portion 13 adjusts the light emission intensity of each of the LED arrays R, G, and B while maintaining the light emission period thereof constant so that the light emission portion 6 attains a target light amount and a target color temperature that correspond to a phase angle. This enables extremely precise control of a light amount and a color temperature, and a color deviation and a difference in brightness of an illumination component attributable to its individual variability can be reduced.

Furthermore, as a modification example of the above-described embodiment, the LED arrays of the respective colors may be set so that currents of the same level are passed therethrough, with the on-periods thereof made to vary. Thus, as shown in FIG. 12, the LED arrays of the respective colors are set to be the same in light emission intensity and made to vary in light emission period. Then, the light control/color control portion 13 integrates, at respective light emission timings of the LED arrays and using the respective light emission periods thereof as integration times, outputs of the light amount sensor 15 thereby to detect respective light amounts of the LED arrays. In this case, based on a light amount and a color temperature that are detected, the light control/color control portion 13 adjusts the light emission period of each of the LED arrays R, G, and B while maintaining the light emission intensity thereof constant so that the light emission portion 6 attains a target light amount and a target color temperature that correspond to a phase angle.

### Fifth Embodiment

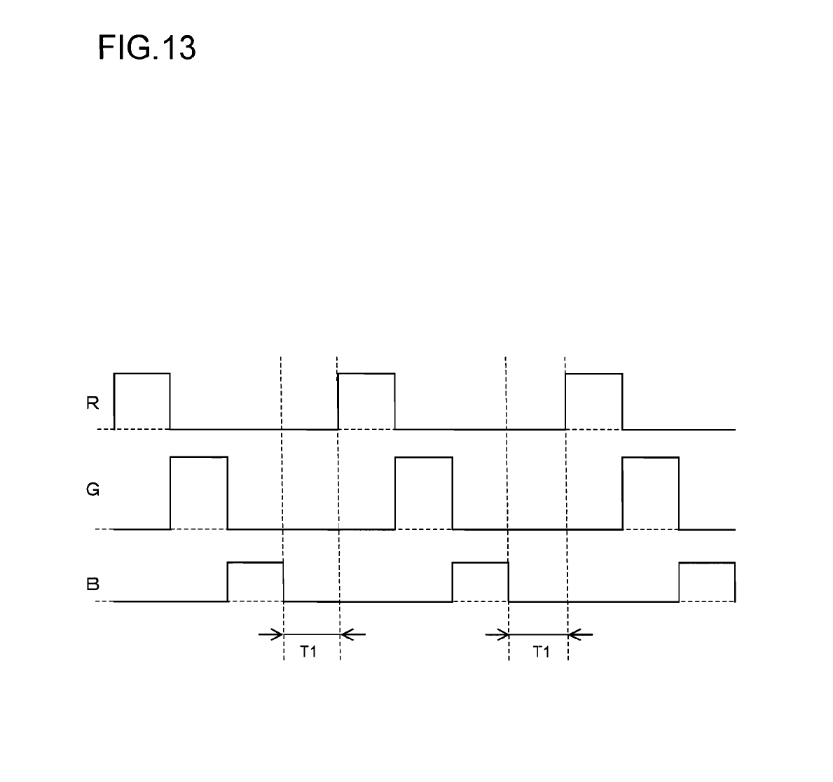

A configuration may be adopted in which, as shown in FIG. 13, light emission timings of LED arrays R, G, and B are staggered, and a period T1 during which none of the LED arrays are emitting light is provided in order that, in the period T1, external light may be detected by a light amount sensor 15 or a color sensor 14. For example, in a room in which curtains are drawn aside to let sunlight shine into the room and that thus is sufficiently bright without the need to turn on an illumination component, illuminance of the external light is detected by the light amount sensor 15, and based on a result of the detection, light amounts of the LED arrays R, G, and B are reduced. This can provide an energy-saving effect. Furthermore, the following is also possible. That is, illuminance and a color temperature of external light are detected by the color sensor 14, and based on results of the detection, the light amounts of the LED arrays R, G, and B are controlled so that a light amount and a color temperature of a light emission portion 6 are adjusted to be appropriate.

What is claimed is:

1. An LED drive circuit to which a light control signal phase-controlled by a phase-control light controller is inputted and that controls a light emission portion having a plurality of LED loads that emit light of different color tones, comprising:
a light control/color control portion that, based on the light control signal inputted, adjusts a current to be passed through each of the LED loads thereby to perform light control and color control of the light emission portion.

2. The LED drive circuit according to claim 1, wherein
the LED loads are a white LED load and a red LED load.

3. The LED drive circuit according to claim 1, wherein
the light control/color control portion decreases a light amount and a color temperature of the light emission portion as a phase angle of the light control signal increases.

4. The LED drive circuit according to claim 1, further comprising:
a phase angle detection portion that detects a phase angle of the light control signal,
wherein the phase angle detection portion detects the phase angle by detecting an average voltage of the light control signal.

5. The LED drive circuit according to claim 1, further comprising:
a phase angle detection portion that detects a phase angle of the light control signal,
wherein the phase angle detection portion detects the phase angle by comparing the light control signal with a reference voltage, generating a pulse signal based on a result of the comparison, and detecting a duty ratio of the generated pulse signal.

6. The LED drive circuit according to claim 1, further comprising:
a detection portion that detects a light amount and a color temperature of the light emission portion,
wherein based on the light amount and the color temperature detected by the detection portion, the light control/color control portion performs light control and color control so that the light emission portion attains a target light amount and a target color temperature that correspond to the light control signal.

7. The LED drive circuit according to claim 6, wherein
the light control/color control portion makes each of the LED loads emit light in a time-divided manner.

8. The LED drive circuit according to claim 7, wherein
the LED loads are the same and constant in light emission period and variable in light emission intensity.

9. The LED drive circuit according to claim 7, wherein
the LED loads are the same and constant in light emission intensity and variable in light emission period.

10. The LED drive circuit according to claim 7, wherein
the detection portion has a light amount sensor and integrates, using, as an integration time, a light emission period of each of the LED loads starting from a light emission timing thereof, an output of the light amount sensor thereby to detect a light amount of the each of the LED loads.

11. The LED drive circuit according to claim 1, further comprising:
a low voltage detection portion that detects that a voltage of the light control signal has been lowered; and
a current drawing portion that, upon the detection of the lowed voltage by the low voltage detection portion, draws a current from a power supply line for supplying power to the LED loads.

12. The LED drive circuit according to claim 1, further comprising:
an edge detection portion that detects an edge of the light control signal; and
a current drawing portion that, upon the detection of the edge by the edge detection portion, draws a current from a power supply line for supplying power to the LED loads.

13. The LED drive circuit according to claim 1, further comprising:
a detection portion that detects illuminance and/or a color temperature of external light,
wherein the light control/color control portion makes each of the LED loads emit light in a time-divided manner and adjusts a light amount of each of the LED loads in accordance with a result of the detection performed by the detection portion in a period during which the LED loads do not emit light.

14. An LED illumination component, comprising:
an LED drive circuit to which a light control signal phase-controlled by a phase-control light controller is inputted and that controls a light emission portion having a plurality of LED loads that emit light of different color tones, including:
a light control/color control portion that, based on the light control signal inputted, adjusts a current to be passed through each of the LED loads thereby to perform light control and color control of the light emission portion; and
the plurality of LED loads that are connected to an output side of the LED drive circuit and emit light of different color tones.
